(19) United States
(12) Patent Application Publication
(10) Pub. No.: US 2005/0061215 A1
(43) Pub. Date: Mar. 24, 2005

(54) Safe intelligent container

(76) Inventors: Feng Wang, Shenzhen (CN); Sidong He, Shenzhen (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 10/942,859

(22) Filed: Sep. 17, 2004

(30) Foreign Application Priority Data
Sep. 18, 2003 (CN) 03280711.2
Nov. 6, 2003 (CN) 200320120805.7

(51) Int. Cl. E05G 1/026; E06B 3/00

(52) U.S. Cl. 109/64

(57) ABSTRACT

A safe intelligent container is composed of container body, door and some electronic safe and intelligent modules installed in the container. The safe intelligent modules are installed in the door, including door shift transducer monitoring the door shift movement and giving out signals. The door has an aperture corresponding to the antenna on the safe intelligent module, and the antennae runs across the antennae aperture and extends out of the container body. We usually use the movement of the door, like the relative movement of two doors or the door movement relatively to the doorcase, to monitor whether the door is unclosed. This effectively solves the existing problems in current safe intelligent containers and makes the structure simpler and installation and operation more convenient.

### FIELD OF THE INVENTION

This invention relates to transportation container, and relates particularly to a kind of safe intelligent container which can monitor whether the door is illegally unclosed.

### BACKGROUND OF THE INVENTION

For existing safe intelligent containers, there is usually a safe intelligent module featured with magnetic function, timing tracking and electronic safe alarm installed on the upper part of the inner corner post at the door end. The module is absorbed into the trough formed by the corner posts both inside and outside, its module arm is pasted to the inner corner post. There is a pressure transducer attached to the module, and the transducer has an antenna that cross the interval space between the door seal adhesive tape and the inner corner post and extends out of the container body. During transportation, the antennae, integrated with containerized traffic monitoring system, performs timing tracking and safe alarm for the container by radio signal transmission. Its working principal include that, when the door is normally closed, the sealing joint strip on the door leaf presses on the pressure transducer on the module, however, if the door is illegally unclosed, the sealing joint strip will turn away from the pressure transducer with the door leaf movement, and on the basis of its pressure relief, the module will give out signal of illegally opening the door. Later on, the module will perform relevant signal processing and give off the alarm signal via the antennae, thus the monitoring system staff will be timely informed and adopt appropriate safe precautionary measures.

The existing safe intelligent containers often have the following problems:

1. The pressure transducer is adopted to perceive the pressure on the door sealing strip and detect whether the door is illegally unclosed, which is not very reliable. The first factor is that the hardness value of the door sealing strip of the container allows some alteration within certain field, while different sealing strip products have different pressure within the same space interval between the door leaf and the doorcase. In particular, the sealing strip on the module will be increasingly aged, while there is an obvious pressure difference between new sealing strips and old ones. The second factor is that, according to some experimental evidences, when the safe intelligent module is installed onto a new container body and the door leaf where the module is installed is unclosed and keeps about 50 mm away from the other door leaf, the sealing strip will still press onto the pressure transducer of the module, however, on the basis of the remained pressure on the sealing strip, the pressure transducer of the module won't give out any illegal door opening signal.

2. The mounting position of the module often cheats the pressure transducer. According to experimental evidences, if insert lamella and other materials alike into the space interval between the sealing strip and the pressure transducer in advance and then open the door, the lamella will still press on the pressure transducer. Thus, the door might be illegally unclosed but out of the monitoring function of the safe intelligent module.

3. The mounting position often brings about any sealing failure. The module arm cross the space interval between the door sealing strip and the inner corner post and gets the antennae extended out of the container body, which may make the sealing strip distorted and fail to press on the doorcase tightly. Under such conditions, all the weathertightness test on the container body with the safe intelligent module installed might fail and bring about water leakage, which often gets the container fail to meet the ISO standards.

4. A suite of safe intelligent device only can detect whether a door leaf is illegally unclosed, while either of the two leafs might be independently and illegally unclosed, so it is required to installed two suites of safe intelligent devices at high costs.

5. The safe intelligent module is installed onto the container by magnetic force adsorbent mode. When the container travels back after unload at some destination, the module is easily lost. That is to say, it is difficult to use the module to manage the container.

In one word, there is inconvenience and defect occurred when the existing safe intelligent containers are put into use, so it is necessary to make some improvement.

### SUMMARY OF THE INVENTION

The purpose of the invention is to offer us a safe intelligent container that adopts a new monitor mechanism to monitor the door opening and unclosing operation.

To solve the above problems and achieve the above goals, this invention adopts a technical proposal as follows:

A safe intelligent container should include container body, door and electronic safe intelligent module installed on the container. The safe intelligent module is installed on a door leaf and has a door shift movement transducer that observes and monitors the door shift movement and gives out signals. There is an antennae aperture in the door at the place opposite to the antennae on the safe intelligent module, and the antennae cross the aperture and extends out of the container body.

In this safe intelligent container, the safe intelligent module is installed on a door leaf. The door case shift movement transducer on the safe intelligent module is an inner door transducer facing towards the inner side of the container body. There is an inner door transducer installed on the inside of the other door leaf and adjacent to the module location. One end of the inductor is connected to the other door leaf, and the other end extends to the place where the inner door transducer will locate when the door is normally closed.

In the safe intelligent container, the inner door transducer is a proximity switch installed on a door leaf. The proximity switch runs into one state when the space interval between itself and the inner door transducer on the other door leaf is less than some assumed value, and it will run into another state and gives out signals when the interval is greater than some assumed value.

In the safe intelligent container, the inner door transducer is a travel switch installed on a door leaf. The contactor of the travel switch is cut off when the space interval between the travel switch and the inner door transducer on the other door leaf is less than some assumed value, and the contactor will be closed up when the interval is greater than some assumed value.

In the safe intelligent container, the inner door transducer is a pressure transducer installed on a door leaf. The pressure transducer runs into one state when the inner door transducer on the other door leaf is pressed down, and it will run into another state and gives out signals when the inductor is loosen.

One end of the inner door transducer is connected with the other door leaf, and the other end extends to the place where the baffle of the inner door transducer will locate when the door is normally closed.

There is an U-shaped top door beam installed on a stile of the door leaf adjacent to the other door leaf, the open end of the U-shaped beam faces towards the inside part of the container body, and there is a antennae aperture in the stile. The safe intelligent module is fixed into the trough in the U-shaped door closing beam, and the antennae on the safe intelligent module cross the antennae aperture on the top door beam and extends out of the container body.

An antennae locking ring is installed between the inside surface of the antennae aperture and the external surface of the antennae, and the antennae locking ring should be seamlessly combined with the antennae aperture and the contact surface of the antennae.

There is a locking bar transducer installed on the safe intelligent module. There is a locking bar transducer induction piece installed on the cylindrical surface in the locking bar bracket connected with the locking beam. There is a locking bar transducer aperture in the door, which is opposite to the location of the locking bar transducer induction module. The locking bar transducer on the safe intelligent module cross the locking bar transducer aperture and extends out side of the container body. The locking bar transducer induction piece keeps away from the locking bar transducer when the door is normally closed, while, when open the door and turnaround the locking bar, the locking bar transducer induction piece will sweep across the locking bar transducer and give out signals. Or, when the locking bar transducer induction piece approaches the location of the locking bar transducer and the door is normally closed, the locking bar transducer induction piece will turn to some location keep more distance away from the locking bar transducer

The locking bar transducer can adopt proximity switch.

The locking bar transducer can adopt travel switch.

In the safe intelligent container, the locking bar transducer can adopt some pressure transducer. The contactor of the pressure transducer will be pressed by locking bar transducer when the space interval between the pressure transducer and the locking bar transducer induction piece is less than some assumed value, and the contactor will be separated from the locking bar transducer when the interval is greater than some assumed value.

In the safe intelligent container, there is a transducer locking ring installed between the inside surface of the locking bar transducer aperture and the external surface of the locking bar transducer, and the transducer locking ring is perfectly combined with the locking bar locking bar aperture and the contact surface of locking bar transducer.

A danger sensitive module is installed in the safe intelligent container.

The danger sensitive module is installed in the U-shaped top door beam, close up to the internal surface of the closed end of the top door beam, one end of the beam is connected to the safe intelligent module and the other end stretches in the reverse direction.

The safe intelligent module and the danger sensitive module can be welded onto the steel angle on the top door beam, or bolted onto the top door beam, or fastened onto the top door beam with Ω-mode mounting plate and common boiling device of locking bar bracket, or soldered, bonded or magnetically attached onto the top door beam.

An U-shaped top door beam is installed on the door, and the open end of the U-shaped beam face towards the inside container body and a doorcase proximity switch is installed on the upper flange of the top door beam. In addition, it is required to open an aperture in the doorcase and install the doorcase proximity switch inductor at the location opposite to the proximity switch, and the doorcase proximity switch is connected to the safe intelligent module via wiring. When the door is normally closed, and the space interval between the proximity switch and the inductor is less than some assumed value, the proximity switch runs into a state; and when the interval is greater then some assumed value, it will run into another state and give out signals.

The doorcase proximity switch can adopt capacitance type proximity switch, or induction type proximity switch or magnetic reed type proximity switch.

The technical scheme above utilizes the door shift movement, like the relative displacement of the two door leafs or the relative displacement of the door to the location of the doorcase, to monitor whether the door is illegally unclosed, which solves the problems occurring among the existing safe intelligent containers and bring simple structure and convenient installation for the container.

### BRIEF DESCRIPTION OF THE DRAWINGS

FIG. 1 is the Partial Front View of Common Container Reformed by this Technical Scheme of Invention

FIG. 2 is the Partial Rear View of FIG. 1

FIG. 3 is the A-A Sectional View of FIG. 1

FIG. 4 is the State Figure of FIG. 3 after Relative Displacement of Right Door Leaf to Left Leaf

FIG. 5 is the B-B Sectional View of FIG. 2

FIG. 6 is the C-C Sectional View of FIG. 2

FIG. 7 is the Enlarged View of Part I of FIG. 3

FIG. 8 is the Enlarged View of Part I in the Other Execution Mode

FIG. 9 is the Enlarged View of Part II of FIG. 3

FIG. 10 is the State Figure of FIG. 9 after the Transducer Induction Piece 23 Turns to the Place Over Against the Location of the Inductor

FIG. 11 is the Enlarged View of Part II in the Other Execution Mode

FIG. 12 is the State Figure of FIG. 11 after the Transducer Induction Piece 23 Turns to the Place Over Against the Location of the Inductor

FIG. 13 is the Fixing Mode of Safe Intelligent Module 9 and Danger sensitive Module 7 in FIG. 2 by another Execution Mode

FIG. 14 is the D-D Sectional View of FIG. 13

FIG. 15 is the Structural Representation of Execution Mode of Safe Intelligent Module 9 with Doorcase Proximity Switch 33 Installed in FIG. 2

FIG. 16 is the E-E Sectional View of FIG. 15

FIG. 17 is the Structural Representation of Relative Unclosed State of Centre Door 2 to Doorcase 31 in FIG. 15

### DESCRIPTION OF THE PREFERRED EMBODIMENT

The following section describes the invention on the base of attached figures and optimized execution cases:

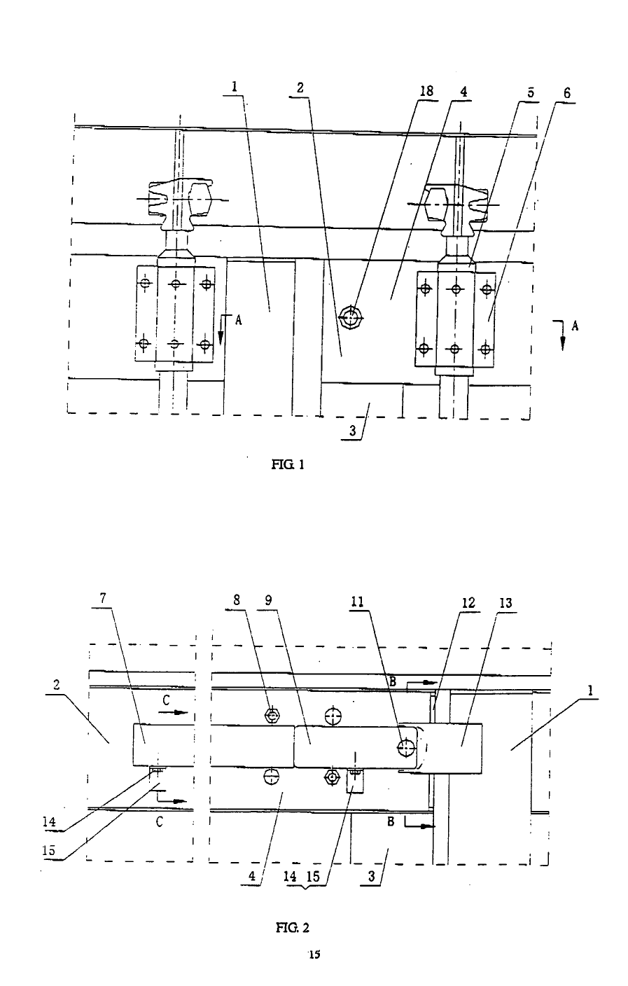

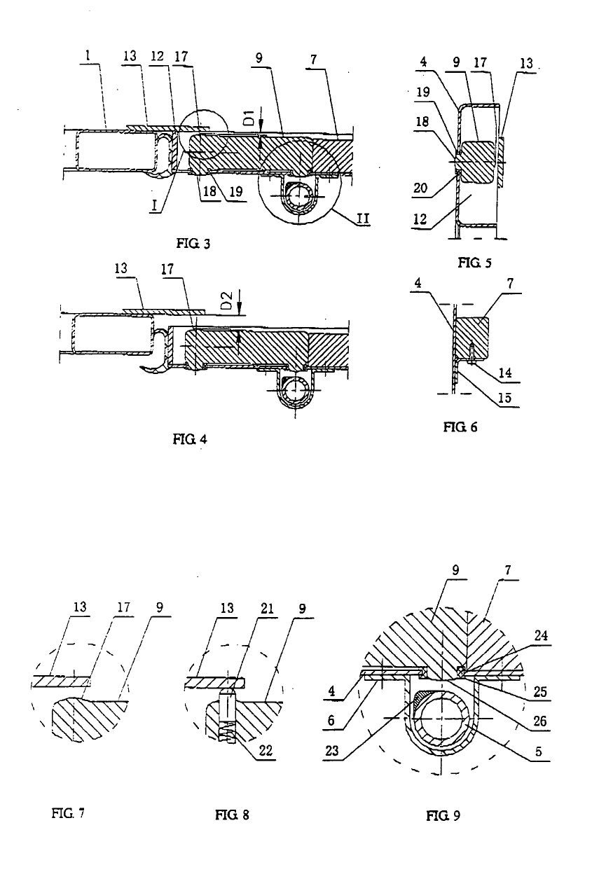

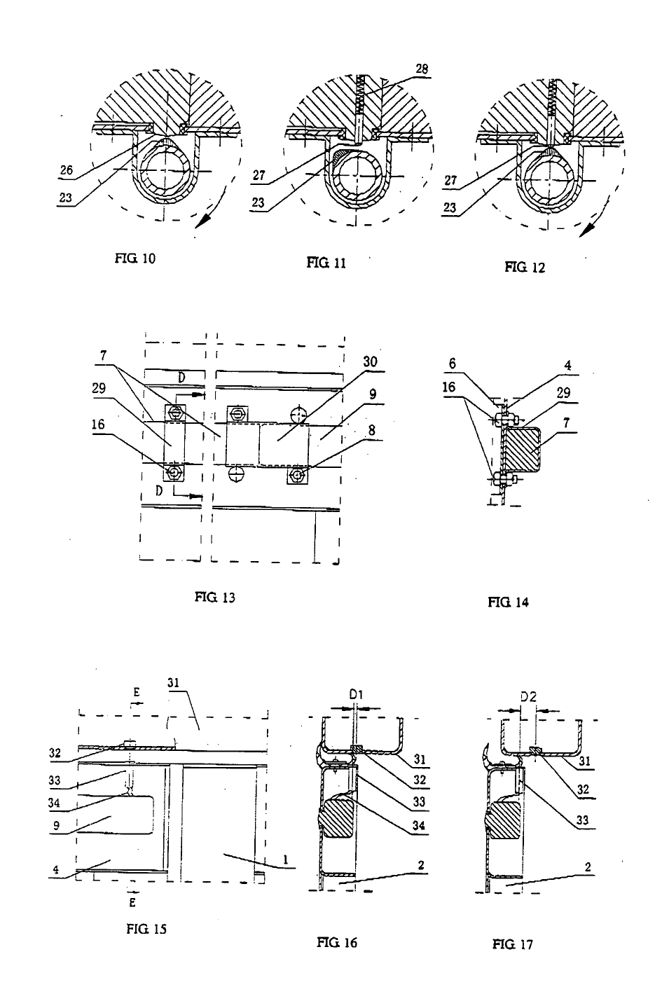

FIG. 1 to FIG. 5 represents the structural relationship of the optimized execution cases of the invention.

The U-shaped top door beam 4 on the right door leaf 2 and adjacent to one end of the right leaf extends to the door brim of the door leaf. The open end of the U-shaped top door beam 4 faces towards the inside part of the container body. Its left end has an end surface closing plate 12 that is connected with the facade, upper and lower side surface of the top door beam by connecting modes like soldering, bonding and riveting, etc. The upright door sill 3 is T-mode jointed and soldered onto the underside plane of the top door beam 4 (the left upright door sill extends to the brim of the door leaf and the top door beam is T-mode soldered to the door upright sill, which is the fashionable structure of door leaf), and there is an antennae aperture 20 in the facade of the top door beam 4 and adjacent to the left door leaf.

The electronic safe intelligent module 9 is installed into the trough of top door beam 4 of the right door leaf and adjacent to the left leaf. The outer side on the left end of the module 9 has a antennae 18, and the antennae 18 can be soldered up with the module 9 by rigid coupling or plugged in the module 9 by removable connection mode, like screwed joint. The antenna 18 cross the antennae aperture 20 and extends out of the container body. The space interval between the antennae 18 and the antennae aperture 20 usually adopts a locking ring 19, or the interval between the module 9 and the facade of the top door beam 4 is pad with edge sealing pad. When the surface of the antennae 18 adopts some elastic materials and the antennae 18 matches the antennae aperture 20 well, no sealing element is required. An inner door proximity switch 17 is installed inside the left end of the module 9, and its contactor extends out from the module 9. Of course, the switch 17 can also be installed as an independent piece connected with the module 9.

There is a baffle 13 installed inside the left door leaf 1 and adjacent to the top door beam 4 of the right door leaf. Its left end is connected to the left door leaf 1 by soldering, riveting, bolting or bonding mode and its right end runs along the left leaf brim and extends outside. According to FIG. 3, when the door is normally closed, the extended end of the baffle 3 should be adjacent to the inner door proximity switch 17 and keeps certain distance D1 from the switch 17. The distance D1 should be less than the operating distance enacted by the inner door proximity switch. According to Future 4, when illegally opening the door gets the right door leaf relatively moves to the left door leaf 1, and the space interval D2 between the inner door approachability switch 17 and the baffle 13 is greater than the operating distance D1, the inner door proximity switch 17 will send signal of illegally opening the door to the safe intelligent module 9, and the module 9 will give off alarm via the antennae 18 and inform all the working staff of the container safe transportation monitoring system of timely adopting safety precautions.

In normal operation, operators use some specialized facility to communicate with and operate the safe intelligent module 9 via its antennae 18.

The inner door proximity switch 17 is a capacitance type proximity switch, or induction one or electromagnetic one.

The inner door proximity switch 17 can also be changed for a travel switch. According to FIG. 8, when the door is normally closed, the elastic element 22 of the travel switch will ensure its contactor 21 to be pressed on the baffle 13, which gets the inner contactor of the travel switch, is cut off. When the two door leafs have any illegal and relative displacement, the baffle 13 is separated from the contactor 21 of the travel switch and the inner contactor of the travel switch is cut off, the travel switch will give out signals of illegally opening the door.

The inner door proximity switch 17 can also be changed for a pressure transducer. The baffle 13 and the contactor of the pressure transducer adopt elastic elements. When the door is normally closed, the elastic element of the baffle 3 will be pressed onto the surface of the pressure transducer. In case of any illegal and relative displacement of the two leafs, and when the elastic element is separated from the surface of the pressure transducer, the pressure transducer will give out signal of illegally opening the door.

When the two door leafs have slight of illegally opening relative to the doorcase at the same time, the relative displacement between the two leafs will be very slim. Thus, the inner door proximity switch 17 will be disabled to detect any illegally opening action. In view of this, a locking bar proximity switch 26 is installed on the safe intelligent module 9.

As FIGS. 3, 9 and 10 shows, a locking bar proximity switch 26 is installed outside the right end of the safe intelligent module 9 and adjacent to the locking bar 5 in the locking bar bracket 6, and there is a locking bar proximity switch aperture 24 at the opposite position of the locking bar bracket 6 in the facade of the top door beam 4. The locking bar proximity switch 26 cross the locking bar proximity switch aperture 24 and extends out of the container body. A proximity switch induction piece 23 is fixed at the place opposite to the location of the locking bar proximity switch 26 on the cylindrical surface in the locking bar bracket 6 of the locking bar 5 by the connection mode of soldering, riveting and bonding. When the door is unclosed, the induction piece 23 will turn around with the locking bar 5 and sweeps across the proximity switch 26, which will turn the switch on, give out signals.

The space interval between the proximity switch 26 and the proximity switch aperture 24 usually adopts a locking ring 25 or insert sealing pad between the module 9 and the facade of the top door beam 4. When the surface of the proximity switch 26 adopts some elastic materials and there is a perfect combination of the proximity switch 26 and the proximity switch aperture 24, no sealing element is required.

The locking bar proximity switch 26 is a capacitance type proximity switch, or induction one or electromagnetic one.

The locking proximity switch 26 can also be changed for travel switch. According to FIGS. 11 and 12, when the door is normally closed, the proximity switch induction piece 230 will keep away from the proximity switch 26 and when the door is unclosed, the induction piece 23 will turn around with the locking bar 5, the travel switch contactor 27 will move and the inner contactor that operates the travel switch will give out signal of opening the door. After the induction piece 23 leaves from the travel switch contactor 27, the contactor 27 will restore its location under the function of the elastic element 28. It is also allowable to enact that the induction piece 23 presses the travel switch contactor 27 in when the door is normally closed and the induction piece 23 keeps away from the travel switch contactor 27 when the door is unclosed.

The locking bar proximity switch 26 can be also changed for pressure transducer. Then, the proximity switch induction piece 23 should adopt elastic element, and its installation location and working principles should be as same as those of the travel switch.

For increasing some induction device to detect whether there is any danger loaded into the container, a danger sensitive module 7 is installed in the top door beam 4, and one of its ends is connected with the safe intelligent module 9 to transmit signals, while the other end runs along the reverse direction. One side of the danger sensitive module 7 is close up to the internal surface of the facade of the top door beam 4.

FIGS. 2, 6, 13 and 14 respectively represent two fixing modes of the safe intelligent module 9 and the danger sensitive module 7. One of the two modes is to fix the angle steel 15 on the facade of the top door beam 4, the bolt 14, the safe intelligent module 9 and the danger sensitive module 7 onto the top door beam by soldering mode, and the other mode is to adopt Ω-mode mounting plates 29 and 30, use the common bolts 8 and 16 of the locking bar bracket to fix the safe intelligent module 9 and the danger sensitive module 7 onto the top door beam. Of course, it is also allowed to adopt soldering, bonding or magnetic force mode to fix the safe intelligent module 9 and the danger sensitive module 7 onto the top door beam.

The safe intelligent 9 and the danger sensitive module 7 can also be installed in the inside door sheet of the door appropriately.

According to FIGS. 15, 16 and 17, the safe intelligent module also has a doorcase proximity switch 33 to detect illegally opening the door. The doorcase proximity switch 33 is fixed on the upper flange of the top door beam 4; a doorcase proximity switch inductor 32 is installed at an aperture opposite to the location of the doorcase proximity switch 33 in the doorcase. The doorcase proximity switch 33 is connected to the safe intelligent module 9 via wiring 34. When the door is normally closed and the space interval between the proximity switch 33 and the inductor 32 is less than some assumed value, the proximity switch 33 will run into a state; and, when the interval is greater than some assumed value, the switch 33 will run into another state and give out alarm signals. The doorcase proximity switch 33 can also adopt capacitance type, induction type or magnetic reed type proximity switch.

The execution structures above can be symmetrically interchanged between the right and the left doors of the container body.

From these technical common senses, we can find that this invention can be executed by various modes without any deviation from its original substances or its adherent characteristics. Therefore, the execution cases disclosed above are just some illustrations but not the only ones. All the reformations and innovations within the scope of the invention or equal to the scope of the invention should be included by the invention.

1. A safe intelligent container, which is composed of container body, door and some electronic safe intelligent module installed on the container. The characteristics of which include: the safe intelligent module is installed on the door, and the safe intelligent module has a door shift movement transducer that monitors the door shift movement and gives out signals. The door has an aperture opposite to the antenna on the safe intelligent module, and the antennae crosses the antennae aperture and extends out of the container body.

2. The safe intelligent container according to claim 1, the characteristics of which include the safe intelligent module is installed on a door and the door shift movement transducer on the safe intelligent module is opposite to the inner door transducer in the container body; an inner door transducer is installed inside on one door close to the safe intelligent module, one end of the inductor is connected to the other door, and the other end is extended to the inner door transducer location when the doors of the container are closed up.

3. The safe intelligent container according to claim 2, the characteristics of which include that the inner door transducer is a proximity switch installed on a door, and the proximity switch will get into one state when the space interval between itself and the inner door transducer on another door is less than some assumed value, and it will run into another state and gives out signals when the interval is greater than some assumed value.

4. The safe intelligent container according to claim 2, the characteristics of which include that the inner door transducer is a travel switch installed on a door, and the inner contact of the travel switch will be cut off when the space interval between itself and the inner door transducer on another door is greater than some assumed value, and it will be closed up and gives out signals when the interval is less than some assumed value.

5. The safe intelligent container according to claim 2, the characteristics of which include that the inner door transducer is a pressure transducer installed on a door, and the pressure transducer will get into one state when the inductor of the inner door transducer is impacted, and it will run into another state and gives out signals when the transducer is loosen.

6. The safe intelligent container according to claim 2 to claim 5, any of the safe containers mentioned in these claims have the common characteristics that one end of the inner door transducer is connected to other door, while the other end is extended to the baffle in the inner door transducer location when the doors of the container are closed up.

7. The safe intelligent container according to claim 1, the characteristics of which include that the door has an U-shaped top door beam extending to the door leaf near to the other door, its U-shaped open end faces inside the container body, there is an antennae aperture in its stile, the safe intelligent module is fixed in the trough of the U-shaped top door beam, and the antennae of the module cross the antennae aperture in the top door beam and extends out side of the container body.

8. The safe intelligent container according to claim 1 or claim 7, the characteristics of which include that an antennae locking ring is installed between the inside surface of the antennae aperture and the external surface of the antennae aperture, and the antennae locking ring is seamlessly combined with the antennae aperture and the contact surface of the antennae.

9. The safe intelligent container according to claim 7, the characteristics of which include that a locking bar transducer is installed on the safe intelligent module, A locking bar transducer induction piece is installed on the cylindrical surface in the locking bar bracket connected with the locking beam. There is a locking bar transducer aperture in on the door, which is opposite to the location of the locking bar transducer induction module. The locking bar transducer on the safe intelligent module cross the locking bar transducer aperture and extends out side of the container body. The locking bar transducer induction piece keeps away from the locking bar transducer when the door is normally closed, while, when open the door and turn around the locking bar, the locking bar transducer induction piece will sweep across the locking bar transducer and give out signals. Or, when the locking bar transducer induction piece approaches the location of the locking bar transducer and the door is normally closed, the locking bar transducer induction piece will turn to some location keep more distance away from the locking bar transducer and give out signals with the door being opened by turning locking bar.

10. The safe intelligent container according to claim 9, the characteristics of which includes that the locking bar transducer can adopt proximity switch.

11. The safe intelligent container according to claim 9, the characteristics of which includes that the locking bar transducer can adopt travel switch.

12. The safe intelligent container according to claim 9, the characteristics of which include that the locking bar transducer can adopt some pressure transducer. The contactor of the pressure transducer will be pressed by locking bar transducer when the space interval between the pressure transducer and the locking bar transducer induction piece is less than some assumed value, and the contactor will be separated from the locking bar transducer when the interval is greater than some assumed value.

13. The safe intelligent container according to claim 9 to claim 11, the characteristics of which include that a transducer locking ring is installed between the inside surface of the locking bar transducer aperture and the external surface of the locking bar transducer, and the transducer locking ring is perfectly combined with the locking bar locking bar aperture and the contact surface of locking bar transducer.

14. The safe intelligent container according to claim 1 or claim 7, the characteristics of which consist that a danger sensitive module is installed in the safe intelligent container.

15. The safe intelligent container according to claim 14, the characteristics of which include that the danger sensitive module is installed in the U-shaped top door beam, close up to the internal surface of the closed end of the top door beam, one end of the beam is connected to the safe intelligent module and the other end stretches in the reverse direction.

16. The safe intelligent container according to claim 15, the characteristics of which include that the safe intelligent module and the danger sensitive module can be welded onto the steel angle on the top door beam, or bolted onto the top door beam, or fastened onto the top door beam with Ω-mode mounting plate and common bolting device of locking bar bracket, or soldered, bonded or magnetically attached onto the top door beam.

17. The safe intelligent container according to claim 1, the characteristics of which include that an U-shaped top door beam is installed on the door, and the open end of the U-shaped beam face towards the inside container body and a doorcase proximity switch installed on the upper flange of the top door beam. In addition, it is required to open an aperture in the doorcase and install the doorcase proximity switch inductor at the location opposite to the proximity switch, and the doorcase proximity switch is connected to the safe intelligent module via wiring. When the door is normally closed, and the space interval between the proximity switch and the inductor is less than some assumed value, the proximity switch runs into a state; and when the interval is greater then some assumed value, it will run into another state and give out signals.

18. The safe intelligent container according to claim 17, the characteristics of which include that the doorcase proximity switch can adopt capacitance type proximity switch, or induction type proximity switch or magnetic reed type proximity switch.
